(19) United States
(12) Patent Application Publication
(10) Pub. No.: US 2007/0075500 A1
(43) Pub. Date: Apr. 5, 2007

(54) Seal for a submersible electric motor

(75) Inventor: Russell Bookout, Fort Wayne, IN (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FRANKLIN ELECTRIC CO., INC., Bluffton, IN (US)

(21) Appl. No.: 11/242,989

(22) Filed: Oct. 4, 2005

(51) Int. Cl. F16J 15/44

(52) U.S. Cl. 277/411

(57) ABSTRACT

A slinger seal for a submersible motor having a shaft is disclosed. The seal comprises a cup having an inner cup surface and a slinger disposed on the shaft and axially spaced from the cup. The slinger has a lower portion defining a cavity proximate to the cup and a seal having a first seal portion engaging the cup inner surface and a second seal portion engaging the shaft. The first seal portion includes a member for maintaining the first seal portion into engagement with the cup inner surface and the second seal includes a spring for biasing the second seal portion into engagement with the shaft.

### CROSS-REFERENCE TO RELATED APPLICATIONS

None

### FEDERALLY SPONSORED RESEARCH OR DEVELOPMENT

Not Applicable.

### TECHNICAL FIELD

The present invention relates to a seal for a submersible electric motor.

### BACKGROUND OF THE INVENTION

Motors intended to be used to drive submersible turbine pumps typically have a shaft seal and incorporate some method of protecting the shaft seal from abrasive material commonly found in a well bore. Shaft seals in smaller motors tend to be of the spring loaded rubber lip variety and, for larger motors, tend to be mechanical face seals.

Known schemes used in preventing debris in a well bore from reaching the shaft seal can be categorized as contacting and non-contacting systems. In the contacting systems, a rotating sealing lip, typically made of rubber, is in contact with a stationary portion of the motor housing. In the non contacting system, a cap that is attached to the shaft fits over a stationary stand-pipe.

According to one prior art system, illustrated in FIG. 1, a shaft-mounted rubber slinger 10 fits loosely over a molded bushing 12, resulting in a clearance fit 14. A pumping action by the rotating slinger 10 helps keep debris away from the shaft seal 16. In this case, the stationary seat of the shaft seal 16 is shown in place below the slinger 10.

According to another prior art system, illustrated in FIG. 2, a rubber slinger 10 has a lip 10a which forms an interference fit on a metal bushing 12′, sealing out sand and other debris. As the lip 10a wears into the metal bushing 12′, a clearance opens therebetween, eventually allowing debris in, to be trapped on the shaft seal 16. In other similar versions, the rubber slinger 10 is replaced with a machined metal cap with clearance to the bushing 12′.

The rubber of the slinger 10 is limited in its ability to compensate for wear due to compression set and the fact that excessive interference causes too much heat to be dissipated.

According to yet another prior art system, illustrated in FIG. 3, a rubber slinger 10 contacts a stamped cup 18 on the inner diameter of the slinger 10. The design of the cup 18 allows a build-up of sand below the slinger 10, leading to a cutting of the stamped cup 18 over time.

### SUMMARY OF THE INVENTION

It is an object of the invention to provide a slinger seal for a submersible motor having a shaft.

In accordance with the invention, the seal comprises a cup defining an inner cup surface, a slinger disposed on the shaft, the slinger having a lower portion defining a cavity proximate to the cup, and a seal having a first seal portion engaging the cup inner surface and a second seal portion engaging the shaft.

It is contemplated that the slinger seal includes a garter spring molded into the seal for biasing the second seal portion into engagement with the shaft.

It is further contemplated that the slinger is axially spaced from the cup.

It is still further contemplated that the slinger seal includes a rigid member molded in the seal first portion.

Other features and advantages of the invention will be apparent from the following specification taken in conjunction with the following drawings.

### BRIEF DESCRIPTION OF THE DRAWINGS

FIG. 1 is a sectional view of one prior art slinger seal for a submersible motor;

FIG. 2 is a sectional view of another prior art slinger seal for a submersible motor;

FIG. 3 is a sectional view of yet another prior art slinger seal for a submersible motor;

FIG. 4 is a sectional view of a first embodiment of a slinger seal for a submersible motor in accordance with the present invention; and

FIG. 5 is a sectional view of a second embodiment of a slinger seal for a submersible motor in accordance with the present invention.

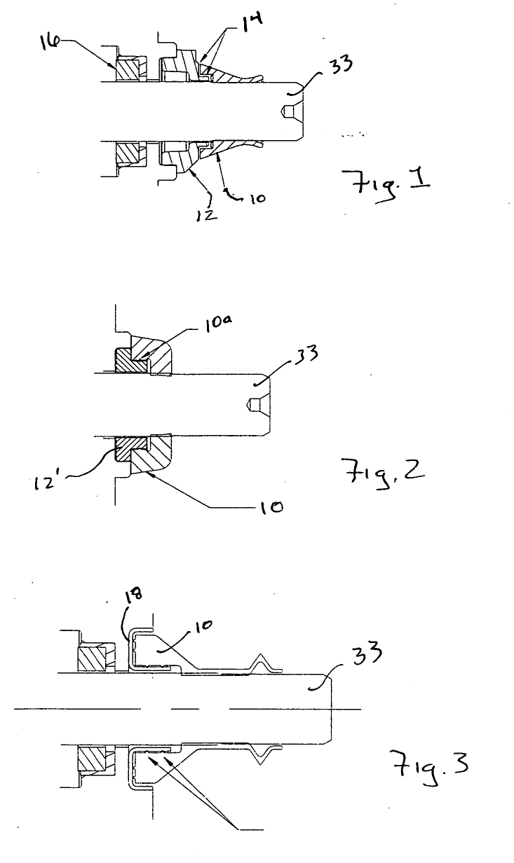

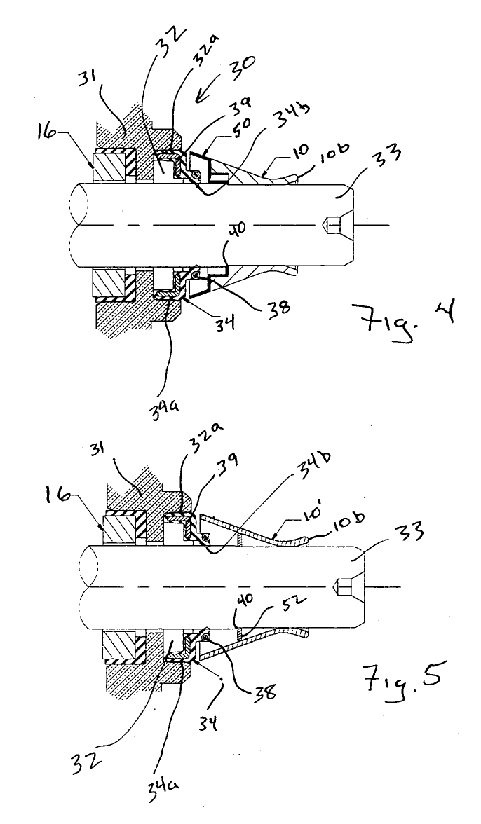

### DETAILED DESCRIPTION OF A PREFERRED EMBODIMENT

While this invention is susceptible of embodiments in many different forms, there is shown in the drawings and will herein be described in detail, preferred embodiments of the invention with the understanding that the present disclosure is to be considered as an exemplification of the principles of the invention and is not intended to limit the broad aspect of the invention to the embodiments illustrated.

A seal 30 in accordance with the invention is illustrated in FIG. 4. The seal 30 is for a submersible motor having an end bell 31 defining an end bell cavity 32 having a peripheral wall 32a and a shaft 33 extending from the end bell cavity 32.

A spring-loaded lip seal 34, preferably made of any number of lip seal materials, such as rubber, leather or hard plastics, is provided. The lip seal 34 has a lip seal first end 34a for engaging the cavity peripheral wall 32a. The lip seal 34 has a lip seal second end in the form of a spring-loaded sealing lip 34b for engaging the shaft 33. The sealing lip 34b projects beyond the portion of its body that presses into the housing. For durability, the spring-loaded lip seal 34 includes a spring 38, which is molded into the lip seal 34 to prevent debris or scale build-up from preventing the seal from functioning properly. The spring 38 may be a garter spring or other such spring as conventionally used in lip seals. In this embodiment, the shaft seal is of the mechanical face seal type and the stationery seat is shown.

The projection of the lip above the housing allows sand to fall away from the sealing lip 34b. If, when the motor is turned off, sand falls down on top of the motor, it cannot build up to a point where it can cause the lip seal 34 to significantly wear.

If wear of the shaft 33 or lip seal 34 does happen, the wear is compensated for by the squeezing action of the garter spring 38 on the sealing lip 34a.

A metal insert 39 is provided in the lip seal 34 for rigidity.

The slinger 10 includes a molded plastic insert 50 to ensure that the slinger 10 cannot collapse against the rubber lip of the stationary part. The slinger 10 fits against a shoulder 40 on the shaft for axial location.

The slinger 10 has a distal portion 10b facing the spline end of the shaft 33 which is shaped so that it will seal sand, scale, or other debris out of the sleeve-type coupling (not shown) that joins the motor shaft 33 and the pump shaft (not shown). The coupling engages the distal portion 10 of the slinger 10 to deflect the rubber as it moves into its position and this is one reason that the slinger 10 is preferably made of rubber. It can, of course, be designed around the limitations of plastic or hard rubber, and is generally eliminated by sealed couplings in larger motors. Sometimes the seal is omitted altogether and the coupling is merely greased prior to installation.

Alternatively, as illustrated in FIG. 5, a one-piece rubber slinger 10′ of a relatively hard rubber, located on a stamped washer 52 that fits the shaft shoulder 40, could be used.

While specific embodiments have been illustrated and described, numerous modifications may come to mind without significantly departing from the spirit of the invention, and the scope of protection is only limited by the scope of the accompanying claims.

What is claimed is:

1. A slinger seal for a submersible motor having a shaft, the seal comprising:
a cup defining an inner cup surface;
a slinger disposed on the shaft, the slinger having a lower portion defining a cavity proximate to the cup; and
a seal having a first seal portion engaging the cup inner surface and a second seal portion engaging the shaft.

2. The slinger seal of claim 1 including a spring for biasing the second seal portion into engagement with the shaft.

3. The slinger seal of claim 2 wherein the spring is molded into the second seal portion.

4. The slinger seal of claim 2 wherein the spring is a garter spring.

5. The slinger seal of claim 1 wherein the slinger is axially spaced from the cup.

6. The slinger seal of claim 1 including a rigid member molded in the seal first portion.

7. The slinger seal of claim 1 wherein the slinger cavity is formed of a plastic portion.

8. The slinger seal of claim 1 wherein the slinger is formed of a relatively hard rubber.

9. A slinger seal for a submersible motor having a shaft, the seal comprising:
a cup having an inner cup surface;
a slinger disposed on the shaft and axially spaced from the cup, the slinger having a lower portion defining a cavity proximate to the cup; and
a seal having a first seal portion engaging the cup inner surface and a second seal portion engaging the shaft, wherein the first seal portion includes a member for maintaining the first seal portion into engagement with the cup inner surface and the second seal includes a spring for biasing the second seal portion into engagement with the shaft.

10. The slinger seal of claim 9 wherein the spring is molded into the second seal portion.

11. The slinger seal of claim 10 wherein the spring is a garter spring.

12. The slinger seal of claim 10 wherein the slinger cavity is formed of a plastic portion.

13. The slinger seal of claim 9 wherein the slinger is formed of a relatively hard rubber.

14. The slinger seal of claim 9 wherein the slinger seal includes a third portion joining the first portion to the second portion.

15. A seal for a submersible motor having an end bell defining an end bell cavity having a peripheral wall and a shaft extending from the end bell cavity, the seal comprising:
a lip seal having a lip seal first end for engaging the cavity peripheral wall and a lip seal second end for engaging the shaft;
a spring for biasing the lip seal second end against the shaft; and
a slinger for mounting on the shaft in spaced relation from the second surface, wherein the slinger includes a slinger cavity for receiving the lip seal second end.

16. The seal of claim 15 wherein the spring is molded into the lip seal.

17. The seal of claim 15 wherein the spring is a garter spring.

18. The seal of claim 15 including a rigid member molded in the lip seal proximate the lip seal first end for maintaining the lip seal first end in engagement with the cavity peripheral wall.
